(19) United States
(12) Patent Application Publication
(10) Pub. No.: US 2005/0239493 A1
(43) Pub. Date: Oct. 27, 2005

(54) Remote monitoring of cardiac electrical activity using a cell phone device

(76) Inventors: Izmail Batkin, Ontario (CA); Riccardo Brun del Re, Ottawa (CA); Steven Carkner, Ottawa (CA); Robert Brookes, Ontario (CA)

Correspondence Address: David J French, P O Box 2486, Station D, Ottawa, K1P 5W6, CA

(21) Appl. No.: 10/513,729

(22) PCT Filed: May 7, 2003
(86) PCT No.: PCT/CA03/00648

§ 371 Date: Nov. 8, 2004

(30) Foreign Application Priority Data
May 7, 2002 (CA) 2385232

(51) Int. Cl. H04M 1/00

(52) U.S. Cl. 455/550.1

(57) ABSTRACT

A bio-monitor is built into a telephone handset or cell phone. Sensors are configured to obtain bio-signals while the handset or cell phone is in the position for normal speaking use of the telephonic device. This enables biosignal acquisition and/or bio-signal telephonic transmission to occur without the need for a position change to effect voice communications. The invention can also be constructed in the form of a case or harness designed to fit over a preexisting cell phone or a pre-existing telephone handset.

### FIELD OF THE INVENTION

This invention relates to remote health monitoring. In particular, it relates to a device whereby cardiac signals such as human heart rate, electrocardiogram (ECG) and other vital signs may be acquired by a patient and transmitted to a remote location.

### BACKGROUND TO THE INVENTION

In the field of cardiology, devices exist that use telephones to transmit a patient's ECG data from the patient's location to a monitoring clinic or doctor's office. Examples include so-called cardiac loop event recorders. These are connected via cables to ECG gel electrodes, quasi-permanently attached to the patient. These devices are able to record ECG data of the patient during arrhythmias.

Other hand-held recorder devices exist that possess permanent, metallic electrodes arranged in a planar configuration, all on one side of the device. These must be temporarily held by the patient against the patient's chest skin in order to pickup the cardiac signal.

Still other devices of the prior art require the patient's two thumbs to be placed on independent, co-planar electrodes on one face of the device.

Traditionally, all these types of devices transmit stored patient ECG data to the monitoring clinic or the doctor's office using a conventional telephone. This is accomplished via an audio signal, which the device modulates with the patient's ECG and which is transmitted through the telephone and subsequently de-modulated by a modem or receiver/adapter at the clinic or doctor's office.

Cardiac monitors based on the co-planar electrode arrangements have also been proposed on the back of a cell phone. One example is U.S. Pat. No. 6,485,416 (November 2002). These require the user to hold the device against the bare skin of the chest, thus not enabling simultaneous vocal communication while monitoring.

U.S. Pat. No. 5,772,586 issued to Nokia Mobile Phones Ltd. describes the transmission of blood glucose data by cell phone. Sensor electronics are restricted to the battery case location and no special consideration is given to ECG.

U.S. Pat. No. 6,102,856 “Wearable Vital Signs Monitoring System” (August 2000) specifies a wireless transmission device to be worn on the chest with various sensors affixed to the patient.

U.S. Pat. No. 5,544,661 entitled “Real-Time Ambulatory Patient Monitor” (August 1996) describes a portable device possessing ECG and photo-plethysmograph (blood oxygen) sensors connected to the patient and providing “wireless wide-area” communications.

In all the above cases, bio-signal monitoring is not accomplished in the posture of normal speaking or communications over a phone handset. In most of the above cases, multiple devices and sensors are required, making the devices more cumbersome to operate than an ordinary telephone or cell phone.

U.S. Pat. No. 6,549,756 (Apr. 15, 2003) describes portable palm-sized personal data communications devices and cellphones fitted with non-co-planar blood-flow sensors. These are designed to maximize the number of sensors in contact with the hand of the user holding the device. This allows for bio-signal monitoring while the device is in normal use for data communications. However the bio-sensors described are incapable of ECG pickup and, due to human body physiology, use of multiple contact points on a single hand of a person as described does not propose acquisition of bio-signals while the telephone unit is positioned for voice communication.

No prior art telephonic device has been proposed that enables ECG or bio-signal collection from the user while the user is holding the device in the position for ordinary use for communications.

It would be desirable for a device to detect and transmit bio-signals such as ECG while being positioned for use essentially as an ordinary telephone. Such a system would offer convenience and would enable real-time or simultaneous bio-signal transmission and verbal communications with the health practitioner, thus providing the patient with instant feedback while saving millions of dollars in healthcare costs.

A consideration in realizing this goal is that, during normal communications, hand-held telephonic devices typically contact the user's body at one hand and at the head. However, commercial cardiac pickup devices of the prior art do not use the head as a pickup location for ECG.

It has been known in the field of medical research that a person's head can be used as one locus for the pickup of ECG signals. In order to generate a difference potential due to cardiac activity, a second pickup electrode must be placed on the torso, arm or leg of the person. Such an arrangement may also provide a differential-type pickup with common mode noise rejection. Due to human body physiology, electrodes placed on the head and left arm produce ECG-like signals on most people.

Other physiologic signals can also be acquired from the head. These include plethysmograph (blood oxygen and pulse) from the ear lobe, and temperature sensing from the inner ear.

The simultaneous handling of bio-signals, once acquired, and audio signals through a telephone or cellular phone can be performed by known technology in a number of ways. These can be classified into four broad categories: Analog Half-Duplex, Analog Full Duplex, Digital Half-Duplex, and Digital Full-Duplex.

A number of present technologies and emerging digital data systems and cellular phone systems enable alternating, or simultaneous, real-time voice and data transmission. An opportunity exists for these technologies to be combined to produce a new and effective system for the remote transmission of bio-signals with the added feature of providing real-time voice telephonic communication between the patient and medical professionals even though they are located at a distance.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described and defined in each of the individual claims, which conclude this specification.

### SUMMARY OF THE INVENTION

The invention is directed to a hand-held, vital signs monitoring device incorporated with, or accompanying a telephone handset or cell phone.

The invention is particularly suited to a hand-held sensor system incorporating one of a variety of head-source bio-sensors, including sensors for blood oxygen, pulse, body-temperature, and ECG incorporated with or accompanying a telephone handset or cell phone.

The invention provides a means by which these signals, including the head-to-arm ECG signal, may be conveniently acquired and telephonically transmitted by the patient via a single, hand-held device, in the form of a telephone handset or a cell phone, while the device is in the position for ordinary communications. “Telephonic communications” as used herein includes transmission of data over a system that will accommodate acoustic, e.g. voice, communications.

The invention therefore enables the simultaneous or alternate communication of bio-data and voice without the need for any interruption arising from repositioning of the device.

According to one aspect, the invention can be realized as a specially designed telephone handset or a specially designed cell phone. According to another aspect, the invention can be realized as a harness, case, attachment, or glove designed to be carried by an existing telephone handset or an existing cell phone.

In both aspects, the invention addresses a specially designed telephone handset or cell phone, or a harness or case designed to be carried by an existing telephone handset or an existing cell phone, which device embodies:
a) a first sensor to be carried on the outer surface of the device in order to establish a first contact with the user's head and receive bio-signals through such first contact;
b) a pickup signal conditioning circuit carried by the device connected to the first sensor to condition received signals for telephonic communication; and
c) a telephonic communication circuit connected to the signal conditioning circuit to provide a telephonic signal corresponding to the bio-signal data for telephonic communication,
   whereby the simultaneous or alternate communication of bio-data and voice may occur without the need for any interruption arising from repositioning of the device.

For the purpose of ECG, a second sensor is positioned on another portion of the surface of the device to establish a second contact with the user's hand to also effect the acquisition of bio-signals through such second contact. Both the first and second sensors may then serve as ECG pickup electrodes for delivery of bio-signals to a differential amplifier contained within the signal conditioning circuit. In addition to the two pickup electrodes, the device of the invention for ECG may also carry a third electrode to serve as a reference electrode, preferably ohmic with a low coupling impedance, positioned to contact either the user's head or the hand when the device is in use and connected to the common for such circuit. The reference electrode serves to establish a reference voltage (ground) for the differential amplifier and improves common mode noise rejection. This reference electrode may be mounted proximately to either the first or the second pickup electrode.

The invention is suitable for ECG but is not restricted to ECG. Other bio-sensors can be incorporated to acquire bio-signals e.g. monitoring of blood oxygen, pulse, and ear temperature etc. The invention therefore enables the pickup, and real-time assessment of the patient's vital signs. Instant feedback can be provided to the patient, as can simultaneous or alternate bio-signal and voice communication during apparently normal telephonic exchange without the need for any interruption arising from repositioning of the device.

According to the invention, the sensed bio-signal is provided to the conditioning circuit, which conditions it to provide the signal, or a surrogate of said signal, for telephonic transmission. Conditioning may include a differential amplifier, a filter, an analysis circuit based upon algorithms to partially analyse the bio-signal before transmission, a compression circuit, a digitising circuit and other known signal manipulating means. Memory may also be provided for delayed transmission of signals. Accordingly, variants of the invention can transmit either the bio-signal, in analog or digitised form, or surrogates for the bio-signal, in real time or on a delayed basis.

A memory in the conditioning circuit may be used to store signals for delayed transmission. Conveniently, an archive memory may be used to store standard bio-data such as standard ECG trace of the user, acquired when the user is healthy. This archived bio-signal may then be sent to distant medical professions, along with contemporary signals, when the user/patient is having a crisis.

When the invention is incorporated into a case, harness, or glove designed to be carried by an existing telephone or cell phone, either an acoustic coupling means or an electrical connection may be employed in order to convey the bio-signal into the telephonic transmission portion of the combined device. In the case of use of a cell phone for ECG, the first and second pickup electrodes, the reference electrode (preferentially all ohmic), and the electrical circuitry of the invention may readily be carried within a case or attachment, coupled to the cell phone by an internal or external connector which extends from the circuitry of the invention to the microphone or data port of the cell phone to permit inclusion of the bio-signal into the cell phone's telephonic communications. A control switch may allow user control to toggle the telephonic communication between bio-signal and voice-only transmissions. Alternately, bio-signal and voice telephonic transmissions, including simultaneous transmissions, may be effected by any one of known means for combining voice and data communication, as further elaborated below.

The electrode placement of the invention on the hand-held telephonic device provides for bio-signal pickup during the course of normal communications. Thus the head-facing sensor is on the same side of the device as the customary earpiece. This enables single-hand operation and simultaneous or alternate, near-simultaneous bio-signal and voice communication through the telephone or cell phone, thus allowing real-time data transmission and telephonic feedback between the patient and the health care practitioner.

A preferred type of pickup electrodes for ECG are active-type electrodes designed to minimize contact potentials and motion artifact as described, for example, in PCT patent applications PCT/CA00/00981 and PCT/CA03/00426, the contents of such applications being adopted herein by reference.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIG. 1 is an illustration of a cell phone of the invention showing locations for the pickup electrodes, the ground reference electrode and the analysis circuit.

FIG. 2 is an illustration of a case of the invention designed to fit onto a pre-existing cell phone.

FIG. 3 is a schematic depiction showing a patient transmitting bio-signals obtained between the hand and ear as in normal telephonic communications.

FIG. 4 is a schematic showing the electrical circuit for an “active” ohmic electrode.

FIG. 5 is a schematic showing the electrical circuit for two “active” ohmic electrodes feeding a signal to a differential amplifier.

FIG. 6 is a functional block diagram of one version for the electronics of the invention.

### DESCRIPTION OF THE PREFERRED EMBODIMENT

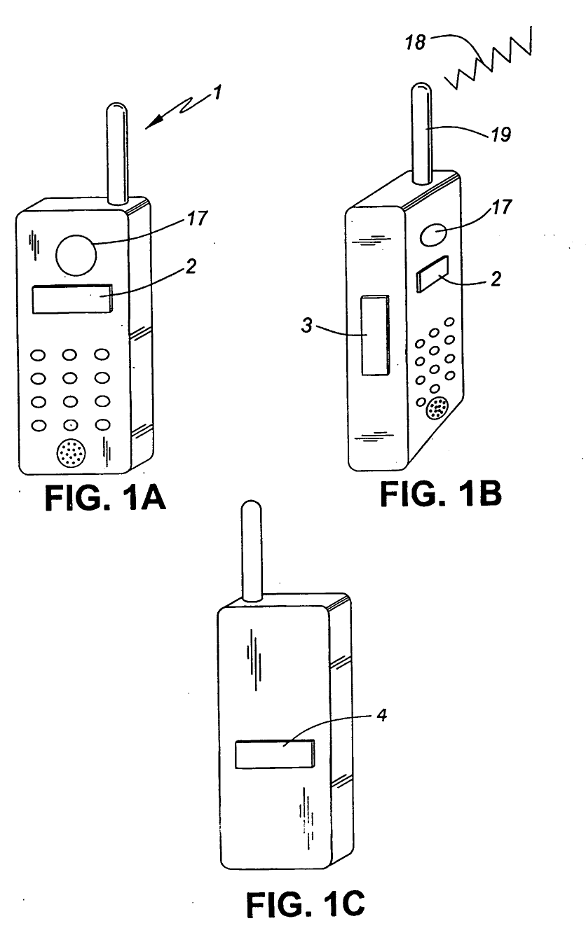

In FIG. 1 a cell phone 1 of the invention is equipped as a cardiac monitoring device, possessing a forward facing, first, head-contacting sensor 2 positioned to contact the face or ear of the user. While sensor 2 is shown in FIG. 1 as being below the earpiece 17 on the cell phone, it may otherwise surround such earpiece 17 or be positioned elsewhere on the cell phone 1 to conveniently contact the user's head during or between telephonic transmissions. To capture ECG signals, a second, side or rear-facing, hand-contacting sensor 3 is positioned to contact the left hand or thumb of the user. And preferably, a reference electrode 4 is positioned on the cell phone 1 to contact either the face or hand of the user. The electrodes may be ohmic or capacitive, the reference electrode being preferably ohmic of the active type.

It is desirable in the case where ohmic electrodes are used for the first and second electrodes, particularly in conjunction with a differential, common-mode noise rejection circuit, for the body-contacting surface of such electrodes to have a volume resistivity in the range of 10exp5 to 10exp11 ohm-cms, more preferably 10exp6 to 10exp10 ohm-cms. With such an electrode it is desirable to feed the signal directly into a preferably on-board, high impedance amplifier—hence constituting an active electrode.

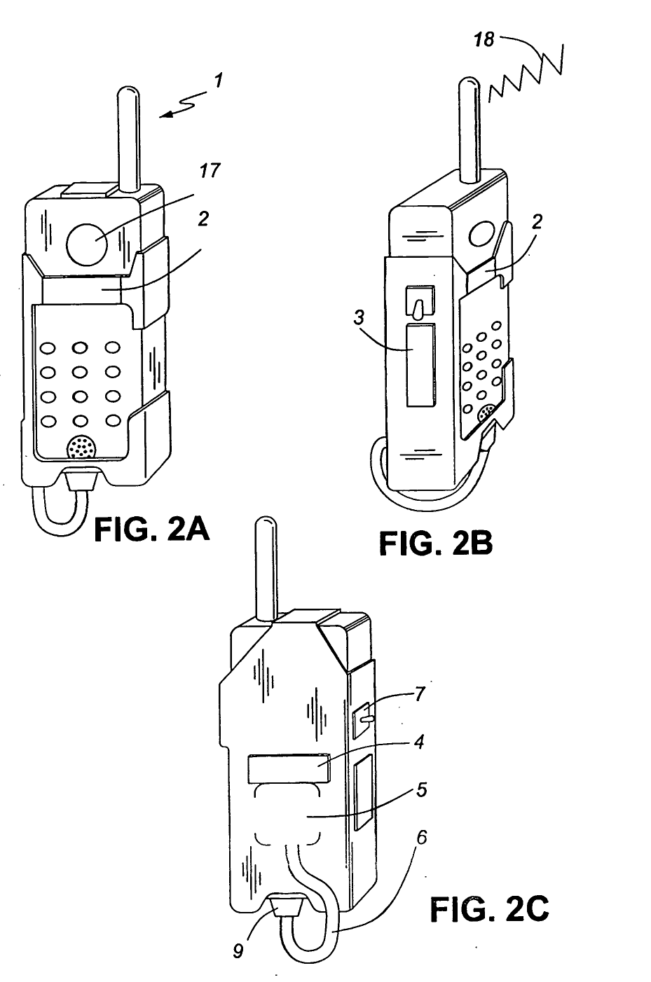

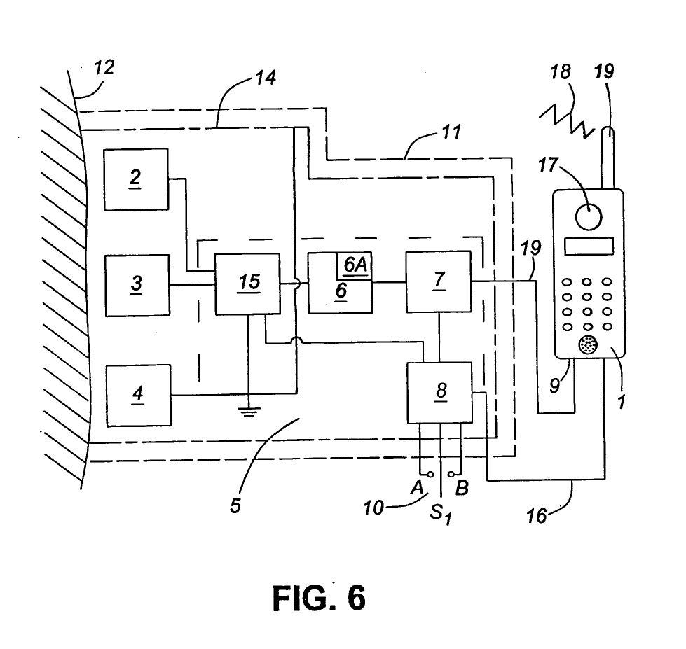

In FIG. 2 an already-existing cell phone 1 is provided with a harness incorporating a first, forward-facing sensor 2 positioned to contact the face or ear of the user; a second, side or rear-facing sensor 3 positioned to contact the left hand or thumb of the user; a reference electrode 4, preferably ohmic, positioned to contact either the face or hand of the user; and an electronic circuit 5 to condition and/or analyse the bio-signal and to digitise and/or modulate the bio-signal in preparation for transmission. A coupling connector 19 delivers the bio-signal to the cell phone input for telephonic transmission 18. Optionally, an input switch 10 may be provided to allow the user to select bio-signal data transfer A or voice transmission B, as shown in FIG. 6.

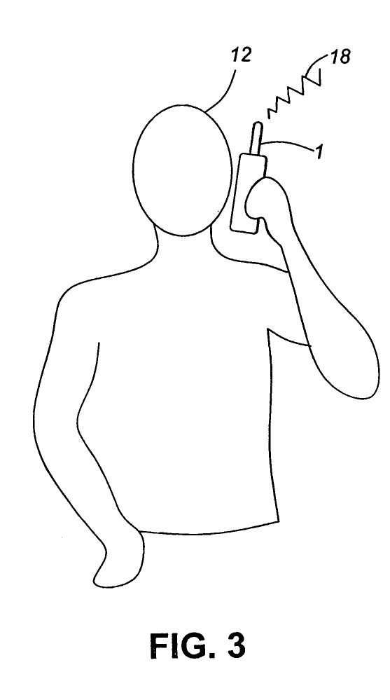

FIG. 3 illustrates a device of the invention in use by a user. When the device 1 is held to an ear as shown in FIG. 3, bio-signals are acquired from the same user posture as in ordinary telephonic use. Use of the left hand is preferred for ECG pickup as this produces a stronger signal for most persons. But this is not a universal rule.

If for any reason this posture is not convenient on a particular individual, then the invention can also be made to operate by placing the face-oriented sensors on other body parts such as the chest or opposed hand.

FIG. 6 illustrates a functional block diagram of the invention removed from the interior of a cell phone, or case for clarity. The outputs from the first sensor 1, the second sensor 2, and the reference electrode 3, are connected to the conditioning circuit 5. Circuit 5 may include analyser means 15 to partially analyse the bio-signal. For the purpose of ECG pickup, the analyser circuit 15 preferably includes a differential amplifier. The analyser circuit 15 may also include means to derive key parameters from the bio-signal, provide band-pass filters, interference filters and produce outputs based on the correlation of multiple bio-signals.

The reference electrode 3 is connected to circuit 5 and is also connected to a recommended electrical shield 14, which overlies the circuitry of the invention in order to maximize the rejection of unwanted electrical interference signals. It has been found useful in some cases to overly electric shield 14 with an additional magnetic shield 11 constructed of mu-metal foil or sheet. This further reduces interference arising from transmission of the telephonic device.

Bio-signals that have been analysed within the circuit 15 may be provided to the memory 6, and subsequently to the modulator 7 within the conditioning circuit 5 which prepares the signal for submission to the telephonic device input 9. The conditioned signal may be in acoustic or electronic form., electronic being indicated. Before submission to the telephonic input 9, however, the modulated bio-signal may be temporarily stored in a buffer memory 6, which is also connected to a controller 8. Controller 8 controls the timing of the data submission into the telephonic device and uses memory 6 to prevent loss of bio-data.

Buffer memory 6 can optionally be made to store or archive several seconds of the patient's ‘normal’ bio-signal in an archive memory 6A. Such a signal can be recorded under highly controlled conditions, such as at the doctor's office, during the patient's optimal health condition. This ‘normal’ signal can be permanently stored and sent to the doctor's office along with each real-time bio-signal transmission, e.g. interspersed. Such a feature would provide the health practitioner with the user's ‘standard’ bio-signal, thus assisting the practitioner in assessing the patient's immediate status.

In the embodiment described previously wherein the invention is in the form of a harness or case to be used with an existing cell phone, the micro-controller 8 can be connected to a user-activated switch 10. In this case, the switch 10 controls a sense circuit in controller 8 which toggles the cell phone through input 9 between of normal voice mode and data transmission mode. The detailed functioning of controller 8 depends on the particular model of cell phone utilized.

Communications over the telephonic link can be effected in a number of electronic modes. Half-Duplex allows the health practitioner to talk to the patient, and to instruct the patient on when to begin and cease sending the bio-signal information. When instructed, the patient switches back to ‘normal’ mode to regain control of the outgoing audio channel and can immediately converse in a normal fashion with the monitoring station.

It is also anticipated that the monitoring station could control the bio-monitoring functions by sending a specific tone or other signal through antenna 21 and link 16 to instruct the device to begin or cease sending bio-signals, thereby removing the need for the patient to activate the device.

Other envisioned voice-over-data capabilities include Full-Duplex, via time-division multiple-access, code division multiple access or frequency division multiple access.

Other systems such as GPRS (General Packet Radio Service), EDGE (Enhanced Data rates for GSM Evolution), High Speed Internet, piggy-back DSL (Digital Subscriber Line) or ADSL (Asynchronous DSL) continue to expand the possibilities for simultaneous data and voice.

As high-speed digital systems continue to proliferate, it is expected that more opportunities for simultaneous transmission of medical data and voice signals will arise. This will not be limited to cellular phone or PSTN systems, but will also encompass cable-television, satellite, micro-cell and pico-cell communication systems. It is also envisioned that a medical telephones could incorporate two, separate voice and data systems that operate completely independently. This will allow the voice portion to connect to a PSTN system and the data portion to connect to any available digital connection including, but not limited to, wired connections, wireless connections, Ethernet, RS232, USB, 802.11 or blue-tooth.

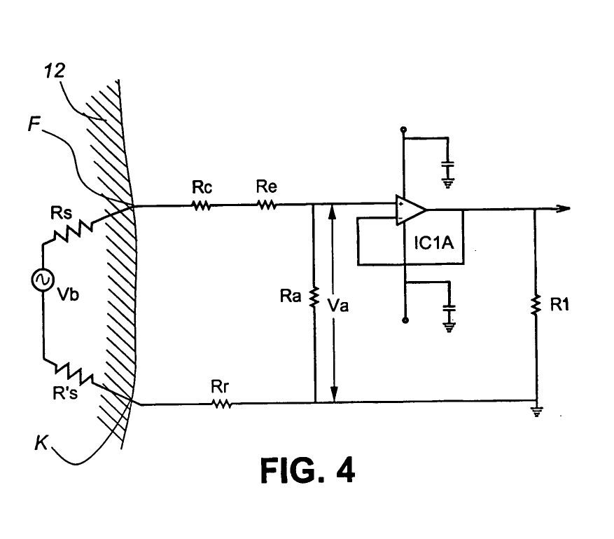

FIG. 4 depicts a pictorial schematic layout for an electrode used to pickup signals originating inside a body 12 for delivery to the conditioning circuit 5. The electrical signal inside the body can be called the body-source, as represented by a voltage Vb. Analyzing this circuit for its DC characteristics, the body source, along with the voltage divider required for the pickup of the bio-signal is illustrated in FIG. 4 wherein:
Rs and R's are the skin resistance;
F is the location of the body-to-electrode interface;
Rc is the contact resistance at the interface F;
Re is the electrode bulk resistance, and
Ra is the resistance across which the output signal Va is measured.

The end of the voltage divider, opposite to the electrode, is connected to the body through resistance Rr at point K. An operational amplifier, IC1A, serves as the sensing electronics.

In the case of passive electrodes connected to an ECG machine, Ra represents the ECG machine input resistance. In the case of active, ohmic pickup electrodes possessing an on-board, internal buffer amplifier acting as an impedance converter, Ra represents the combined resistance of the sensing circuit as bridged by the sensing resistor.

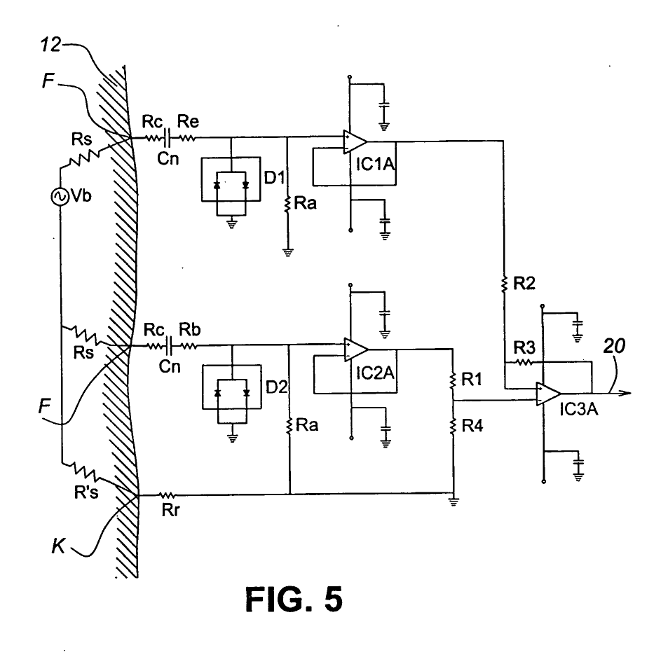

In order to protect the sensing circuitry from overload voltages, Ra may be paralleled by two parallel, reversely oriented diodes such as diodes exemplified by Panasonic MA198CT. Diodes D1, D2 are shown in FIG. 5. At the low signal levels provided by the pick-up electrodes, such diodes exhibit high forward resistances, having a resistance of on the order of 10 exp 12-13 ohms. The forward resistance of these diodes before conduction occurs at low voltages is on the order of 10 exp 13 ohms. By choosing diodes with a forward breakdown voltage that is above the level of the signal of interest, the “reset” function of the input resistance of the high impedance amplifies can be improved.

FIG. 5 shows a differential input electronic circuit that reduces or eliminates common mode noise. In FIG. 5 two pick-ups using operational amplifiers IC1A, IC2A similar to that of FIG. 4 are used to drive a differential amplifier IC3A which further conditions the signal for transmission by shielded wire 20 to a further portion of the conditioning circuit 5, and eventually to the telephonic communication circuit of the phone. By use of this differential signal detection circuit, common mode noise arising from the reference electrode, the body, and external noise sources will be minimized.

In summary, using the invention a new and useful means for telemonitoring of patients may be provided.

### CONCLUSION

The foregoing has constituted a description of specific embodiments showing how the invention may be applied and put into use. These embodiments are only exemplary. The invention in its broadest, and more specific aspects, is further described and defined in the claims, which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

1. A telephone device for a user in the form of a telephone handset or cell phone, or a case, or harness for attachment to a pre-existing telephone handset or cell phone in combination with a pre-existing telephone handset or cell phone, comprising:
a) a first sensor carried on the outer surface of the device in order to establish contact with the user's head and acquire bio-signals through such first contact;
b) a pickup signal conditioning circuit carried by the device and connected to the first sensor to condition acquired bio-signals into conditioned signals for subsequent telephonic communication;
c) a telephonic communication circuit connected to the signal conditioning circuit to provide a telephonic signal corresponding to the bio-signal data for telephonic communication, and
d) voice communication means positioned on the device to convey voice messages to and from the user through the telephonic communication circuit while the device is in position to receive bio-signals through such first contact,
whereby the simultaneous or alternate communication of bio-data and voice may occur without the need for any interruption arising from repositioning of the device.

2. A telephone device as in claim 1 comprising a second sensor positioned on another portion of the surface of the device to establish contact with the user's hand to also effect the acquisition of said bio-signals through such second contact, said second sensor being connected to the pickup signal conditioning circuit to condition acquired signals into conditioned signals for subsequent telephonic communication.

3. A telephone device as in claim 2 wherein:
1. the first sensor is a first cardiac pickup positioned to contact the user's head during normal hand-held telephonic communications; and
2. the second sensor is a second cardiac pickup electrode positioned to contact the left hand of the user during normal hand-held telephonic communications.

4. A telephone device as in claim 3 wherein the first and second sensors are ohmic electrodes combined with:
a) a third ohmic reference electrode positioned to contact the user's skin at either the face or hand location;
and wherein:
b) the pickup signal conditioning circuit includes a differential, common-mode noise rejection circuit with a circuit ground; and
c) the third reference electrode is connected to the circuit ground.

5. A telephone device as in claim 4 wherein said first, second and reference electrodes have a body-contacting surface layer which has a volume resistivity in the range of 10exp5 to 10exp11 ohm-cms.

6. A telephone device as in claim 2 comprising a case or harness shaped to be carried by a cell phone or phone handset wherein said case or harness carries:
a) said first sensor array;
b) said second sensor array; and
c) said signal conditioning circuit,
and said signal conditioning circuit is connected to the cell phone or phone handset to deliver said conditioned signals corresponding to the bio-signal data for telephonic communication by the cell phone or phone handset.

7. A telephone device as in claim 6 comprising acoustic coupling means whereby said signal conditioning circuit is connected to the cell phone or phone handset to deliver said conditioned signals corresponding to the bio-signal data acoustically for telephonic communication by the cell phone or phone handset.

8. A telephone device as in claim 7 wherein said cell phone or phone handset comprises an electrical input port and said device comprises an input connection extending therefrom to said signal conditioning circuit to deliver said conditioned signals corresponding to the bio-signal data for telephonic communication by the cell phone or phone handset.

9. A device as in claim 8 comprising switch means connected to the a telephonic communication circuit to permit selection between data transmission and voice communications.

10. A device as in claim 9 comprising telephonic circuit means operating on the basis of one of the following systems namely, Analog Half-Duplex, Analog Full Duplex, Digital Half-Duplex, and Digital Full-Duplex, to permit transmission of the patient bio-signal and verbal communication by telephonic communication.

11. A device as in claim 10 comprising telephonic circuit means whereby a monitoring station receiving said telephonic communication controls the bio-monitoring functions by sending a specific tone or other audio signal to instruct the device to begin or cease sending bio-signals.

12. A device as in claim 11 wherein the ohmic reference electrode is mounted proximately to one of the pickup electrodes.

13. A device as in claim 12 wherein said signal conditioning circuit comprises a memory in the conditioning circuit whereby signals may be stored for delayed transmission.

14. A device as in claim 13 wherein said signal conditioning circuit comprises an archive memory to store a baseline or healthy bio-signal of the user, acquired when the user is healthy, this archived bio-signal being available to be sent by telephonic communication along with contemporary conditioned signals arising when the user/patient is having a crisis.

15. A telephone device as in claim 1 comprising a case or harness shaped to be carried by a cell phone or phone handset wherein said case or harness carries:
a) said first sensor array; and
b) said pickup signal conditioning circuit,
said signal conditioning circuit being connected to the cell phone or phone handset to deliver said conditioned signals corresponding to the bio-signal data for telephonic communication by the cell phone or phone handset.
